(19) United States
(12) Patent Application Publication
(10) Pub. No.: US 2013/0211863 A1
(43) Pub. Date: Aug. 15, 2013

(54) Method and System of Reverse Bidding for Facilitating the Sale of Travel Services (Auto, Air, Hotel, Bed and Breakfast)

(71) Applicant: Michael Cole White, The Colony, TX (US)

(72) Inventor: Michael Cole White, The Colony, TX (US)

(73) Assignee: Michael Cole White, The Colony, TX (US)

(21) Appl. No.: 13/732,351

(22) Filed: Dec. 31, 2012

Related U.S. Application Data
(60) Provisional application No. 61/556,804, filed on Jan. 11, 2012.

(51) Int. Cl. G06Q 30/08

(52) U.S. Cl. CPC G06Q 30/08
USPC 705/5

(57) ABSTRACT

The invention provides a new and unique process for offering and administering an Internet based reverse bidding (nontraditional) auction of travel related services whereby Buyers submit travel desire for services and Sellers of desired services compete to fulfill by bidding to provide said services based on a plurality of options which may or may not include or be limited to the lowest price. This is exactly opposite of how traditional auctions work today where Buyers bid on a Seller's product or service and where the winner is based on the highest bid of the buyer.

### CROSS-REFERENCE TO RELATED APPLICATIONS

This application claims the benefit of the U.S. Provisional Application No. 61/556,804 with Filing Date Jan. 11, 2012.

### FIELD OF THE INVENTION

The invention relates to the field of ecommerce. Specifically, the invention relates to a method and system for facilitating a transaction between a buyer and seller of travel related goods and services including, but not limited to, accommodation rentals, vehicle rentals, tour services, and air transportation via a reverse bidding auction where the seller bids to provide travel related services to the buyer and where the winning bid is not solely determined by price.

### BACKGROUND OF THE INVENTION

Unlike traditional auctions where Sellers post a product or service for sale, Buyers bid, and the highest Buyer bid wins upon closing time of the auction, this method and system provides a means for Buyers to request travel related goods and services and Sellers to bid on the fulfillment via a plurality of fulfillment options. Winning entry may be based on a plurality of conditions which the Buyer determines and may or may not be related to lowest price. Also, unlike traditional auctions, Buyers are presented all matching seller bids with details so that the Buyer can determine which Seller offer most closely matches the Buyer's desire.

Currently, Buyers have few options for purchasing travel related goods and services through traditional auctions where Buyers are limited to only those goods and services presented by Sellers and where the Buyer's ability to obtain said goods and services are based solely upon the Buyer submitting the highest bid. Methods and systems do not exist to assist Buyers in obtaining travel related goods and services based on criteria other than Buyer offering the highest bid for published auction of said goods and services. Thus, a need exists for improved methods and systems that facilitate transactions through a Buyer initiated Reverse Bidding Auction.

### BRIEF SUMMARY OF THE INVENTION

The invention is based on an Internet-based reverse bidding (nontraditional) auction of travel related services whereby Buyers submit a plurality of travel desires and services and Sellers of desired services compete based on a plurality of methods to fulfill by bidding to provide said services. Buyers evaluate responses from Sellers based not only on lowest bid amount but quality and value of services.

The present invention recognizes that traditional auctions favor the Seller and that auction options do not currently exist which favor the Buyer. This nontraditional auction includes certain refinements to traditional auctions that improve Buyer favorability and convenience thus presenting the Buyer with a truly unique benefit.

### DETAILED DESCRIPTION OF THE INVENTION

The present invention describes a method and system to facilitate an on-line reverse bidding auction between a buyer of travel related services “Buyer(s)” and travel related service providers “Seller(s)” of travel related services including, but not limited to, accommodation rentals, vehicle rentals, tour services, and air transportation or any combination thereof.

Buyers access the method and system to submit information regarding travel desires including, but not limited to, travel services desired (accommodations, vehicle rentals, air transportation, tour services, dates of travel, location desired, number of people, price, class of service, etc.) via a plurality of online options including, but not limited to, form submissions and profile updates.

Sellers may enroll in a subscription based service to the method and system and/or may query submissions of Buyers on an ad hoc basis in order to be informed of Buyer submissions. A charge may or may not be assessed to Seller for either method.

Data collected via the above prescribed submission are collected and stored via a backend database on a server computer. The data is disseminated to interested Seller(s) who review submissions and decide whether or not to respond with bids back to Buyer(s)—usually for competitive/lower price or competitive/greater benefits or combination of both.

The method and system includes a backend process to search through a database containing records associated with travel services offered for sale based on, but not limited to, geographical location, services offered, desired benefits, or price matching. The method uses proprietary business rules to compare Buyer desire(s) to the service(s) of the Seller. Upon matching criteria, Seller(s) are notified of matching buyer submissions with details via a plurality of electronic means including, but not limited to, email, file feeds, manual or systematic database search/entry, texts, and profile updates. Seller(s) may also have visibility of detailed bids of other Seller(s) so that a more competitive offer may be submitted to Buyer(s).

Sellers interested in bidding to provide services for Buyer respond via a plurality of electronic means including, but not limited to, email, texts, phone call, manual or systematic database entry, and profile updates. Responses may be collected/aggregated, stored via backend database, and presented to Buyer(s) per Buyer's chosen delivery method.

Anonymous entries may also be created by Buyer(s). Buyer may or may not be identified only if Buyer accepts Seller's offer.

Anonymous responses may also be provided to Buyer(s) as part of Seller(s) response. Seller may or may not be identified only if Buyer accepts Seller's offer.

Buyers may accept offer from any Seller(s) and in doing so arranges for Seller to provide the travel service(s) to the Buyer in accordance with the defined terms of the Buyer and Seller upon submission and may be binding, and a penalty may or may not be applied if a Seller and or a Buyer does not complete the transaction.

The present invention has been described in terms of several examples solely for the purpose of illustration. Persons skilled in the art will recognize from this description that the invention is not limited to the method and system and examples described, but may be practiced with modifications and alterations limited only by the spirit and scope of the appended claims.

The invention claimed is:

1. A method and system comprising the use of a server computer for hosting an Internet-based reverse auction of travel related services where the server computer stores the Buyer's and Seller's input.

2. A method and system as in claim 1, wherein Buyers can establish options for travel including, but not limited to, reverse auction time frame, preferred price, dates, location, services, and amenities.

3. A method and system as in claim 1, wherein Sellers of travel related services can create a profile including but not limited to, commercial details, preferred price, dates, location, services and amenities offered. Additionally, Sellers can enroll to receive notifications when a matching Buyer request is received.

4. A method and system as in claim 1, wherein said server computer uses a plurality of proprietary business rules to match the requests of Buyers to Sellers.

5. A method and system as in claim 1, wherein Sellers may opt to review and/or receive notifications for matched Buyer requests as determined in claim 4.

6. A method and system as in claim 1, wherein Sellers may opt to respond via a plurality of methods including but not limited to, email, text, phone, and mail to matched Buyer requests as determined in claim 4.
